(19) United States
(12) Patent Application Publication
(10) Pub. No.: US 2011/0307638 A1
(43) Pub. Date: Dec. 15, 2011

(54) DATA TRANSMISSION CABLE WITH OTG FUNCTION

(75) Inventor: Johnny CHEN, Santa Ana, CA (US)

(73) Assignee: I/O INTERCONNECT, LTD., Santa Ana, CA (US)

(21) Appl. No.: 13/155,732

(22) Filed: Jun. 8, 2011

Related U.S. Application Data
(60) Provisional application No. 61/353,201, filed on Jun. 9, 2010.

(51) Int. Cl. G06F 13/42

(52) U.S. Cl. 710/63

(57) ABSTRACT

A data transmission cable provided by the present invention is suitable for connecting a first electronic apparatus and a second electronic apparatus. The data transmission cable of the present invention has a first connection module, a second connection module, and an OTG controller. The first and second connection modules are configured for connecting with the first and the second electronic apparatuses respectively. The OTG controller is coupled to the first and the second connection modules for capturing a data from the second electronic apparatus and transmitting the data to the first electronic apparatus, so as to respond a data capturing requirement from the first electronic apparatus.

### CROSS-REFERENCE TO RELATED APPLICATIONS

The application claims priority of U.S. provisional patent application Ser. No. 61/353,201 filed on Jun. 9, 2010, the contents of which are hereby incorporated by reference.

### FIELD OF THE INVENTION

The present invention relates to a data transmission cable, and more particularly to a data transmission cable with the USB interface.

### BACKGROUND OF THE INVENTION

Universal serial bus is a serial bus standard for connecting a computer system and a peripheral device for applying to many types of information and communication production such as the personal computer or the mobile device wildly. In addition, the USB is further expended to the related fields of the camera equipment, the digital TV (set-top box, STB), the game machine, etc.

Since the USB interface becomes the best choice on each types of information productions, configuring the USB interface on one information production is a basis requirement. Although the specification of USB interface develops to USB 2.0 and USB 3.0 from USB 1.0 and USB 1.1, the generally USB structure as shown as the FIG. 1, is a star topology structure in which a personal computer 100 is the center. The personal computer 100 completes the link with the peripheral devices, such as a digital camera 106, a smart phone 108, a mouse 110, and a mobile disk 112 through the hub 102 or a keyboard with hub 104 as shown in the FIG. 1.

The standard USB structure is a master/slave structure. The USB host (i.e. the personal computer 100) is the master, and the peripheral devices are the slaves. Only the USB master can control the data transmission, and the USB peripheral devices cannot start the data transmission. The USB peripheral devices only can respond the instruction from the master. Thus, in the structure, a user needs the personal computer 100 for executing the function of data transmission and communication. Therefore, the user cannot use the smart phone 108 to download a picture file from the digital camera 106 directly, because the smart phone 108 must connect to the master (host) which is the personal computer 100 to execute the data transmission and communication with the digital camera 106.

For promoting the convenience of the USB interface, the USB OTG (On-The-Go) is developed. The OTG is a supplement standard of the USB 2.0 for becoming the peripheral device with the USB OTG chip as a master. Referring to the FIG. 2, the smart phone 204 having a USB OTG chip can link with the digital camera 106 via the USB transmission cable 202 for downloading the picture file from the digital camera 106 directly. Currently, more and more peripheral devices support the OTG function, but most of peripheral device without the OTG function. Therefore, how to make the peripheral device without supporting the OTG function executing the function of data transmission and communication directly is a big problem.

### SUMMARY OF THE INVENTION

Therefore, the present invention is to provide data transmission cable for linking to electronic apparatuses and making one of electronic apparatuses capturing the data from another electronic apparatus directly.

The present invention further provides an electronic production, can capturing data from a electronic apparatus through the OTG function.

Furthermore, the present invention provides a method for assisting a first electronic apparatus without the OTG function capturing data from a second electronic apparatus directly through the OTG function.

A data transmission cable provided by the present invention is suitable for connecting a first electronic apparatus and a second electronic apparatus. The data transmission cable of the present invention has a first connection module, a second connection module, and an OTG control module. The first and second connection modules are configured for connecting with the first and the second electronic apparatuses respectively. The OTG control module with a buffer is coupled to the first and the second connection modules. Therefore, the control module captures a data from the first electronic apparatus, so as to save the data into the buffer through the first connection module. Then, the OTG control module transmits the data saved into the buffer to the second electronic apparatus via the second connection module for responding a data capturing requirement from the second electronic apparatus.

From another viewpoint, an electronic production provided by the present invention has an electronic apparatus and a data transmission cable. The electronic apparatus without the OTG function is connected to the data transmission cable. The data transmission cable has a first USB male connector, an OTG control module, and a cable connection module. The first USB male connector is configured for connecting the USB port. In addition, the OTG control module is coupled to the first USB male connector and the cable connection module. When another electronic apparatus connects with the cable connection module, the OTG control module with a buffer captures a data from the electronic apparatus connected with the cable connection module, so as to save the data into the buffer. Then, the OTG control module transmits the data saved into the buffer to the electronic apparatus connected with the first USB male connector for responding a data capturing requirement from the electronic apparatus connected with the first USB male connector.

In one embodiment of the present invention, the OTG control module has a first OTG controller, a second OTG controller, and a processor. The first and the second OTG controllers are coupled to the cable connection module and the first USB male connector. Wherein, the first OTG controller is configured as a host terminal, and the second OTG controller is configured as a peripheral terminal. In addition, the processor is coupled to the first and the second OTG controllers respectively and the buffer. Therefore, the processor saves the data from the first OTG controller to the buffer, and transmits the data saved into the buffer to the electronic apparatus connected with the first male USB connector for responding to the data capturing requirement.

From another viewpoint, a method provided by the present invention is suitable for the first electronic apparatus without the OTG function. First, the method provides a data transmission cable with the OTG function. When the first electronic apparatus and a second electronic apparatus connect with the data transmission cable, the first electronic apparatus is set as a host device and the second electronic apparatus is set as a storage device. When a data capturing requirement is generated by the first electronic apparatus, the method sets the data transmission cable as a host device for capturing a data from the second electronic apparatus. In addition, the captured data is saved into a buffer configured into the data transmission cable. Furthermore, the data transmission cable is set as a peripheral device, so as to move the data saved into the buffer to the first electronic apparatus for responding the data capturing requirement.

In one embodiment, the method further sets the second electronic apparatus as a peripheral storage device, so as to allow the host device capturing data with another electronic apparatus. In another embodiment, the method sets the second electronic apparatus as a network storage device.

Since the data transmission cable has the OTG function, it can make the electronic apparatus without supporting the OTG function to capture data from another electronic apparatus through the OTG function.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a conventional USB topology diagram.

FIG. 2 is a schematic diagram of a smart phone with the USB OTG chip linking to the digital camera.

FIG. 3A is a schematic diagram of an electronic production according to one preferred embodiment of the present invention.

FIG. 3B is a schematic diagram of an OTG control module according to one preferred embodiment of the present invention.

FIG. 4 is a schematic diagram of the electronic apparatus according to one preferred embodiment of the present invention.

FIG. 5 is a flow chart of a method for the electronic apparatus 302 capturing data from another electronic apparatus according to one preferred embodiment of the present invention.

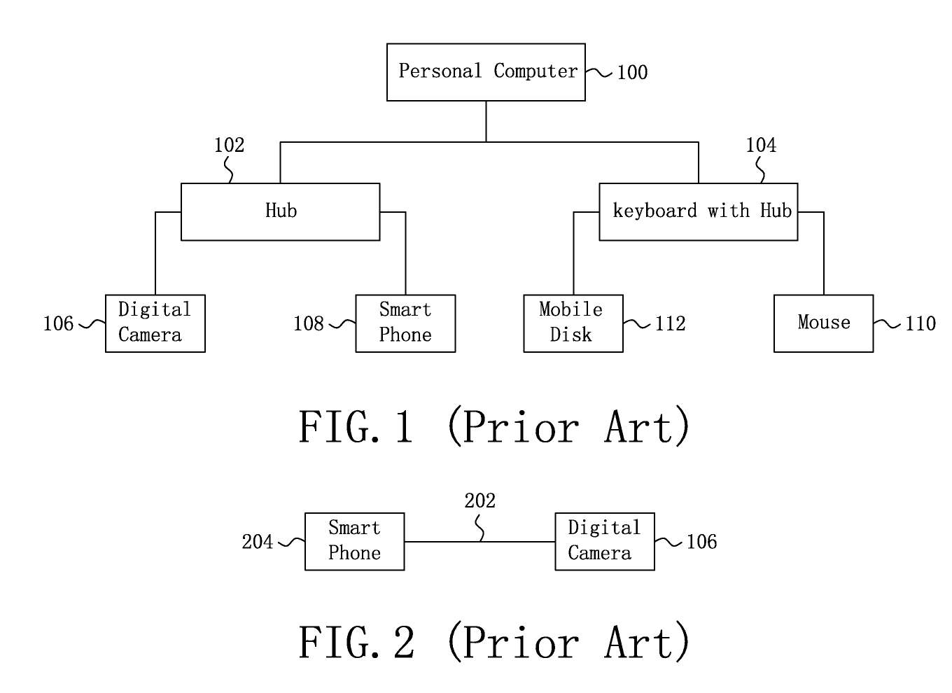

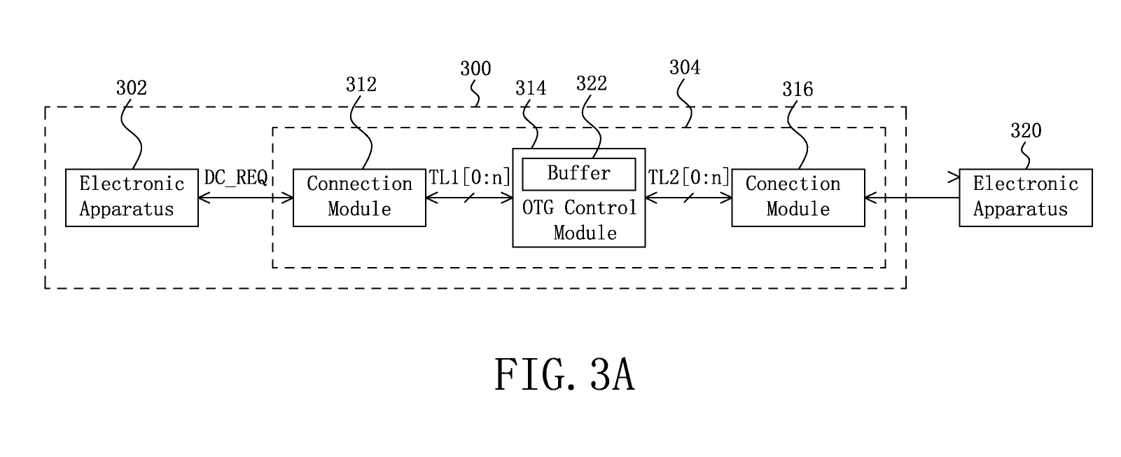

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

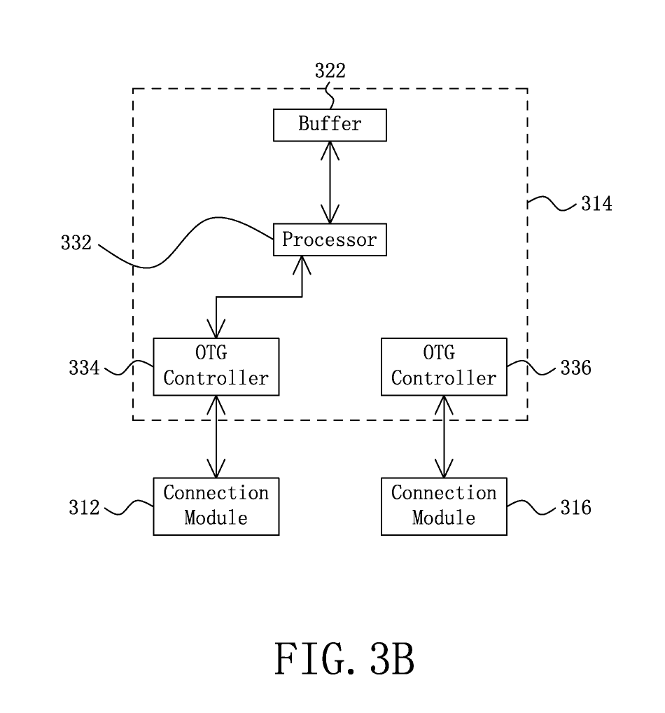

FIG. 3A is a schematic diagram of an electronic production according to one preferred embodiment of the present invention. Referring to the FIG. 3A, the electronic production 300 of the exemplary embodiment comprises an electronic apparatus 302 and a data transmission cable 304. Wherein, the data transmission cable 304 is configured for connected with the electronic apparatus 302. In some embodiments, the electronic apparatus 302 is probably a smart phone, a package computer, a tablet computer, etc.

Referring to the FIG. 3A continually, the data transmission cable 304 comprises a connection module 312, an OTG control module 314, and a connection module 316. In this embodiment, the OTG control module 314 with a buffer 322 is coupled the connection modules 312 and 316 via the transmission lines TL1[0:n] and TL2[0:n] respectively, wherein n is an integral number greater than 0.

FIG. 3B is a schematic diagram of the OTG control module 314 according to one preferred embodiment of the present invention. Referring the FIG. 3B, the OTG control module 314 further has a processor 332, a plurality of OTG controllers 334 and 336. The processor 332 is coupled to the buffer 322 and the OTG controllers 334 and 336 respectively. In addition, the OTG controller 334 is coupled to the connection module 312, and the OTG controller 336 is coupled to the connection module 316. In particularly, the OTG controller 334 is configured as a peripheral terminal, and the OTG controller 336 is configured as a host terminal.

The connection module 312 probably comprises a USB male connector, such as a normal USB male connector or a mini USB male connector, which is configured to connect to the electronic apparatus 302. In other embodiments, the connection module 312 also configures a USB port, such as a normal USB port.

Similarly, the connection module 316 probably has a USB male connector, such like the normal USB male connector or the mini USB male connector. Furthermore, the connection module 316 also can configure a normal USB port.

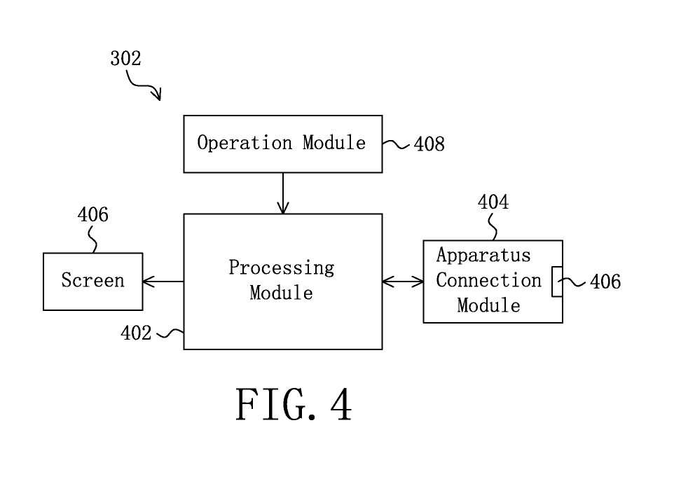

FIG. 4 is a schematic diagram of the electronic apparatus 302 according to one preferred embodiment of the present invention. Referring to the FIG. 4, the electronic apparatus 302 at least has a processing module 402 and an apparatus connection module 404. The apparatus connection module 404 couples to the processing module 402 and has a USB port 406. In the exemplary embodiment, the USB port 406 is a normal USB port or a mini USB port, so that the connection module 312 can be inserted into the USB port 406. In particularly, the apparatus connection module 404 is not supporting the OTG function.

In addition, the electronic apparatus 302 further has a screen 406 and an operation module 408. The processing module 402 is coupled to the screen 406 and the operation module 408. Wherein, the operation module 408 includes at least one operation unit, such as a real key, a touch-control panel, a joy stick, a roll wheel, a trackball, etc.

Referring to the FIGS. 3A to 4, when the electronic apparatus 302 connects the data transmission cable 304 via the connection module 312 and another electronic apparatus 320 connects the data transmission cable 304 through the connection module 316, the electronic apparatus 302 is set as a host device and the electronic apparatus 320 as a storage device by the processor 332. In some embodiments, the electronic apparatus 320 is probably a digital camera, a card reader containing a memory card, a music player, a flash memory storage driver, etc.

In addition, the processor 332 may link the electronic apparatus 320 to read the content of the electronic apparatus 320 and show the content of the electronic apparatus 320 on the screen 406 of the electronic apparatus 302. Therefore, a user can get the information about the content of the electronic apparatus 320 through the screen 406. When the user wants to capture a data, such as a picture file, a document file, a music file, a video file, a files group, file folder, etc., from the electronic apparatus 320 through the electronic apparatus 302, the user would operate the operation unit in the operation module 408 to issue a data capturing requirement DC_REQ.

Meanwhile, Since the OTG controller 336 is set as a host terminal as above maintained, the data transmission cable 304 is seen a host device from the electronic apparatus 320. Therefore, the processor 332 can control the OTG controller 336 to capture the data asserted by the user from the electronic apparatus 320 via the connection module 316. Then, the processor 332 saves the captured data into the buffer 322. In another way, since the OTG controller 334 is set as a peripheral terminal, the data transmission cable 304 is seen a peripheral storage device from the electronic apparatus 302. Therefore, the processor 332 moves the data saved into the buffer 322 to the OTG controller 334, and controls the OTG controller transmit the data to the electronic apparatus 302 via the connection module 312 for responding the data capturing requirement DC_REQ. It is seen that the electronic apparatus 302 capture the data from the electronic apparatus 320 directly.

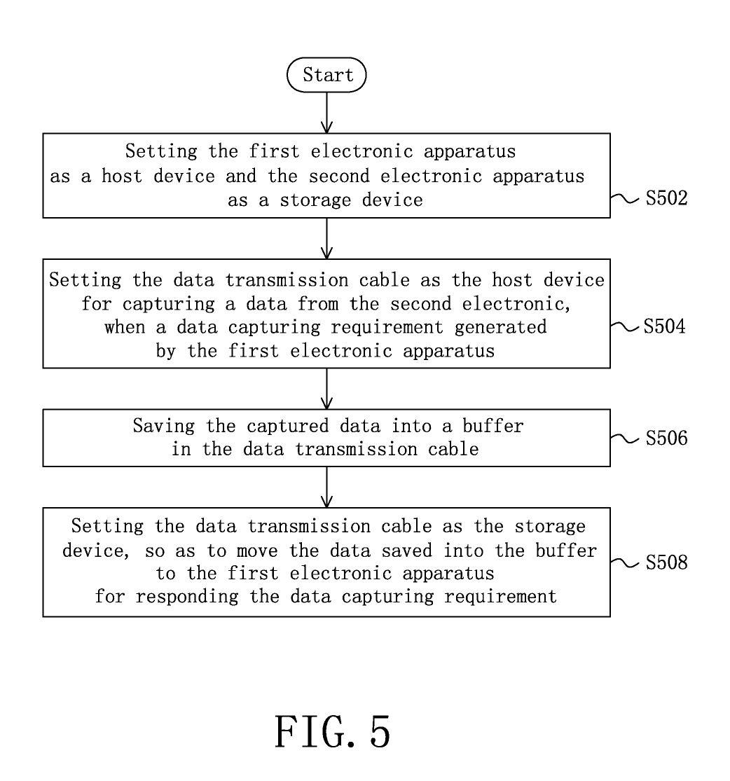

FIG. 5 is a flow chart of a method for a first electronic apparatus without the OTG function capturing data from a second electronic apparatus according to one preferred embodiment of the present invention. Referring to the FIG. 5, a data transmission cable with the OTG function is provided to connect the first and the second electronic apparatuses. When the first and second electronic apparatuses connect the data transmission cable respectively, the fist electronic apparatus is set as a host device, and the second electronic apparatus is set as a storage device, as the description in the step S502. In some embodiments, the second electronic apparatus is set as a peripheral storage device. In other embodiments, the second electronic apparatus is set as a network storage device.

Next, in the step S504, when a data capturing requirement is generated by the first electronic apparatus, the data transmission cable is set as the host device for capturing a data from the second electronic apparatus. Then, as the description in the step S506, the captured data is saved into a buffer configured in the data transmission cable. In addition, the step S508 is executed to set the data transmission cable as a peripheral device to move the data saved into the buffer to the first electronic apparatus for responding the data capturing requirement.

In summary, since the present invention provides a data transmission cable with the OTG function for connecting the first and second electronic apparatuses, the first electronic apparatus can use the OTG function to capture the data from the second electronic apparatus via the data transmission cable even the electronic apparatus without the OTG function. Therefore, such first electronic apparatus, like the smart phone or tablet computer can capture the data from another electronic easily.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A data transmission cable, suitable for connecting a first electronic apparatus and a second electronic apparatus, comprising:
a first connection module, for connecting with the first electronic apparatus; and
a second connection module, for connecting with the second electronic apparatus; and
an OTG control module, having a buffer and being coupled to the first connection module and the second connection module for capturing a data from the first electronic apparatus and transmitting the data to the second electronic apparatus for responding a data capturing requirement from the second electronic apparatus.

2. The data transmission cable according to claim 1, wherein the OTG control module further comprises:
a first OTG controller, coupled to the first connection module and configured as a host terminal for accessing the data from the first apparatus through the first connection module, when the data capturing requirement is sent to the transmission cable;
a processor, coupled to the first OTG controller and the buffer for saving the captured data, which is accessed by the first OTG controller, into the buffer; and
a second OTG controller, coupled to the processor and the second connection module and configured as a peripheral terminal for transmitting the data saved into the buffer to the second electronic apparatus through the second connection module, so as to respond the data capturing requirement.

3. The data transmission cable according to claim 1, further comprising a buffer for registering the transmitted data between the first connection module and the second connection module.

4. The data transmission cable according to claim 1, wherein the first connection module has a USB port or a first USB male connector.

5. The data transmission cable according to claim 4, wherein the first USB male connector is a normal USB male connector or a mini USB male connector.

6. The data transmission cable according to claim 1, wherein the second connection module has a USB port or a second USB male connector.

7. The data transmission cable according to claim 6, wherein the second USB male connector is a normal USB male connector or a mini USB male connector.

8. An electronic production, comprising:
an electronic apparatus, without the OTG function; and
a data transmission cable, having:
a first USB male connector, for connecting with the electronic apparatus;
an OTG control module, having a buffer and being coupled to the first USB male connector; and
a cable connection module, coupled to the OTG controller, wherein when another electronic apparatus connects with the cable connection module, the OTG control module captures a data from the electronic apparatus connected with the cable connection module, so as to save the data into the buffer and transmits the data saved into the buffer to the electronic apparatus connected with the first USB male connector for responding a data capturing requirement from the electronic apparatus connected with the first USB male connector.

9. The electronic production according to claim 8, wherein the OTG control module further comprises:
a first OTG controller, coupled to the cable connection module and configured as a host terminal for accessing the data from the first apparatus through the cable connection module, when the data capturing requirement is generated from the electronic apparatus;
a processor, coupled to the first OTG controller and the buffer for saving the captured data, which is accessed by the first OTG controller, into the buffer; and
a second OTG controller, coupled to the processor and the first USB male connector and configured as a peripheral terminal for transmitting the data saved into the buffer to the electronic apparatus connected with the first male connector, so as to respond the data capturing requirement.

10. The electronic production according to claim 8, wherein the electronic apparatus comprises:
a processing module; and
an apparatus connection module, without the OTG function configured to couple with the processing module and having an apparatus USB port.

11. The electronic production according to claim 8, wherein the first USB male connector is a normal USB male connector or a mini USB male connector.

12. The electronic production according to claim 9, wherein the cable connection module has a cable USB port or a second USB male connector.

13. The electronic production according to claim 12, wherein the second USB male connector is a normal USB male connector or a mini USB male connector.

14. A method for a first electronic apparatus without the OTG function capturing data from a second electronic apparatus, comprising:
providing a data transmission cable with the OTG function and a buffer to connect the first electronic apparatus and the second electronic apparatus respectively;
setting the first electronic apparatus as a host device and the second electronic apparatus as a storage device;
setting the data transmission cable as the host device for capturing a data from the second electronic, when a data capturing requirement generated by the first electronic apparatus;
saving the captured data into the buffer in the data transmission cable; and
setting the data transmission cable as the storage device, so as to move the data saved into the buffer to the first electronic apparatus for responding the data capturing requirement.

15. The method according to claim 14, further comprising setting the second electronic apparatus as a peripheral storage device, so as to allow the host device capturing data from the second electronic apparatus.

16. The method according to claim 14, further comprising setting the second electronic apparatus as a network storage device, so as to allow the host device capturing data from the second electronic apparatus.
